(19) United States
(12) Patent Application Publication
(10) Pub. No.: US 2021/0264300 A1
(43) Pub. Date: Aug. 26, 2021

(54) SYSTEMS AND METHODS FOR LABELING DATA

(71) Applicant: CACI, Inc.- Federal, Arlington, VA (US)

(72) Inventors: Tyler Staudinger, Denver, CO (US); Ross Massey, Arlington, VA (US); Wolfgang Kern, Arlington, VA (US); Jasen Halmes, Arlington, VA (US); Jonathan Von Stroh, Arlington, VA (US); Troy Wallace, Arlington, VA (US); Thomas Gordon Walter Huntley, Littleton, CO (US); Jon Kyle Pula, Aurora, CO (US)

(73) Assignee: CACI, Inc.- Federal, Arlington, VA (US)

(21) Appl. No.: 17/120,392

(22) Filed: Dec. 14, 2020

Related U.S. Application Data
(60) Provisional application No. 62/979,824, filed on Feb. 21, 2020.

(51) Int. Cl. G06N 5/04; G06N 20/00

(52) U.S. Cl. CPC G06N 5/04; G06N 20/00

(57) ABSTRACT

An artificial intelligence (AI) system may be configured to efficiently annotate most if not all unlabeled image data. Some embodiments may: provide, to an object-detection, machine-learning (ML) model, a plurality of unlabeled data such that the object-detection model predicts a plurality of regions; correct at least one vertex of bounds of at least one of the regions such that the bounds fit tighter around an object; convert the regions to first subregions by cropping the first subregions from the unlabeled data; and provide the first subregions to an embedding, ML model configured to output feature vectors for each of the first subregions.

### CROSS-REFERENCE TO RELATED APPLICATIONS

This application claims the benefit of the priority date of U.S. provisional application 62/979,824 filed on Feb. 21, 2020 and entitled “Machine Learning Method and Apparatus for Labeling Image Data,” the content of which is incorporated by reference herein in its entirety. This disclosure relates to (i) U.S. provisional application 62/979,801 filed on Feb. 21, 2020, (ii) U.S. nonprovisional application concurrently filed herewith under Docket No. 046850.025221 as “Machine Learning Method and Apparatus for Detection and Continuous Feature Comparison,” and (iii) U.S. nonprovisional application concurrently filed herewith under Docket No. 046850.025281 as “Reasoning from Surveillance Video via Computer Vision-Based Multi-Object Tracking and Spatiotemporal Proximity Graphs,” (iv) U.S. provisional application 62/979,810 filed on Feb. 21, 2020, and (iv) U.S. nonprovisional application concurrently filed herewith under Docket No. 046850.025201 as “Systems and Methods for Few Shot Object Detection,” the content of each of which being incorporated by reference herein in its entirety.

### TECHNICAL FIELD

The present disclosure relates generally to systems and methods for semi-automated (or fully-automated) labeling of portions of content items.

### BACKGROUND

The training of a deep learning network may be referred to as a deep learning method or process. The deep learning network may be a neural network, Q-learning network, dueling network, or any other applicable network. In some embodiments, deep learning techniques may be used to solve complicated decision-making problems. For example, deep learning networks may be trained to adjust one or more parameters of a network with respect to an optimization goal.

Supervised learning is the machine learning task of learning a function that maps an input to an output based on example input-output pairs. It may infer a function from labeled training data comprising a set of training examples. In supervised learning, each example is a pair consisting of an input object (typically a vector) and a desired output value (the supervisory signal). A supervised learning algorithm analyzes the training data and produces an inferred function, which can be used for mapping new examples. And the algorithm may correctly determine the class labels for unseen instances.

Unsupervised learning is a type of machine learning that looks for previously undetected patterns in a dataset with no pre-existing labels. In contrast to supervised learning that usually makes use of human-labeled data, unsupervised learning does not. An example approach is to perform cluster analysis, e.g., which identifies commonalities in the data and reacts based on the presence or absence of such commonalities in each new piece of data.

Semi-supervised learning makes use of supervised and unsupervised techniques, by combining a small amount of labeled data with a large amount of unlabeled data during training. Unlabeled data, when used in conjunction with a small amount of labeled data, can produce considerable improvement in learning accuracy.

Reinforcement learning is a technique in the field of artificial intelligence where a learning agent interacts with a simulated environment and receives observations characterizing a current state of the environment. Namely, a deep reinforcement learning network is trained in a deep learning process to improve its intelligence for effectively making predictions. Reinforcement learning may be based on a theory that given the condition under which a reinforcement learning agent can determine what action to choose at each time instance, the agent can find an optimal path to a solution solely based on experience of its interaction with the environment.

Deep reinforcement learning (DRL) techniques capture the complexities of an environment in a model-free manner and learn about it from direct observation. DRL can be deployed in different ways such as for example via a centralized controller, hierarchal or in a fully distributed manner. There are many DRL algorithms and examples of their applications to various environments.

Labeling data is a most time consuming and expensive process, e.g., in creating supervised machine learning models. Accuracy of the labeling typically suffers under time, financial, and labor resource constraints. For example, the pretraining labeling can be problematically ambiguous, task specific, or admit of multiple equally correct answers.

### SUMMARY

Preparing high-quality (e.g., accurate) training data from large quantities of data is very labor-intensive and time-consuming so there is a need to accelerate and make more efficient the labeling process, e.g., of every video frame or other pieces of content. Systems and methods are disclosed for rapid, accurate, and/or efficient labeling of image data.

Accordingly, one or more aspects of the present disclosure relate to a method for: providing, to an object-detection, machine-learning (ML) model, a plurality of unlabeled data such that the object-detection model predicts a plurality of regions; correcting at least one vertex of bounds of at least one of the regions such that the bounds fit tighter around an object; converting the regions to first subregions by cropping the first subregions from the unlabeled data; and providing the first subregions to an embedding, ML model configured to output feature vectors for each of the first subregions.

The method is implemented by a system comprising one or more hardware processors configured by machine-readable instructions and/or other components. The system comprises the one or more processors and other components or media, e.g., upon which machine-readable instructions may be executed. Implementations of any of the described techniques and architectures may include a method or process, an apparatus, a device, a machine, a system, or instructions stored on computer-readable storage device(s).

### BRIEF DESCRIPTION OF THE DRAWINGS

The details of particular implementations are set forth in the accompanying drawings and description below. Like reference numerals may refer to like elements throughout the specification. Other features will be apparent from the following description, including the drawings and claims. The drawings, though, are for the purposes of illustration and description only and are not intended as a definition of the limits of the disclosure.

FIG. 1 illustrates an example of a semi-supervised, machine-learning system in which labels are predicted, in accordance with one or more embodiments.

FIG. 2 illustrates a process for labeling unlabeled data, in accordance with one or more embodiments.

FIG. 3A illustrates an originally unlabeled image with a newly predicted bounding polygon added to it, in accordance with one or more embodiments; and FIG. 3B illustrates a chip that is cropped from this original image using coordinates of the vertices of the predicted polygon.

FIG. 4 illustrates a process for manually eliminating object(s) from a cluster of similar objects, in accordance with one or more embodiments.

FIG. 5 illustrates a process for labeling unlabeled data, in accordance with one or more embodiments.

### DETAILED DESCRIPTION

As used throughout this application, the word “may” is used in a permissive sense (i.e., meaning having the potential to), rather than the mandatory sense (i.e., meaning must). The words “include,” “including,” and “includes” and the like mean including, but not limited to. As used herein, the singular form of “a,” “an,” and “the” include plural references unless the context clearly dictates otherwise. As employed herein, the term “number” shall mean one or an integer greater than one (i.e., a plurality).

As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other.

Unless specifically stated otherwise, as apparent from the discussion, it is appreciated that throughout this specification discussions utilizing terms such as “processing,” “computing,” “calculating,” “determining,” or the like refer to actions or processes of a specific apparatus, such as a special purpose computer or a similar special purpose electronic processing/computing device.

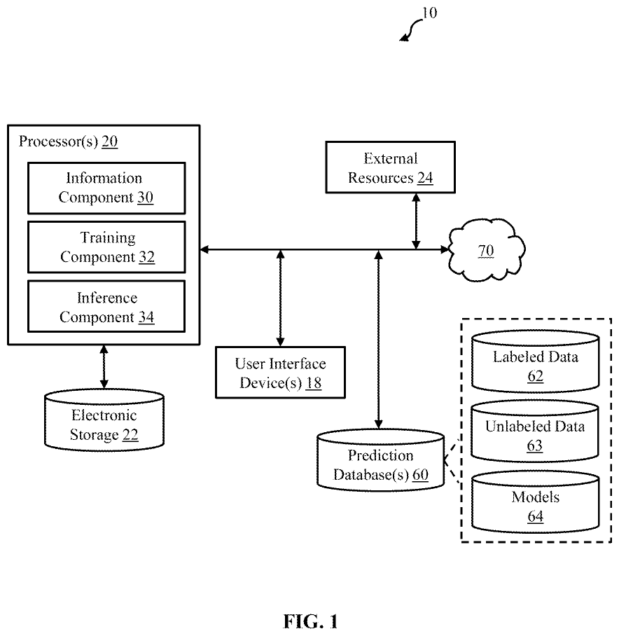

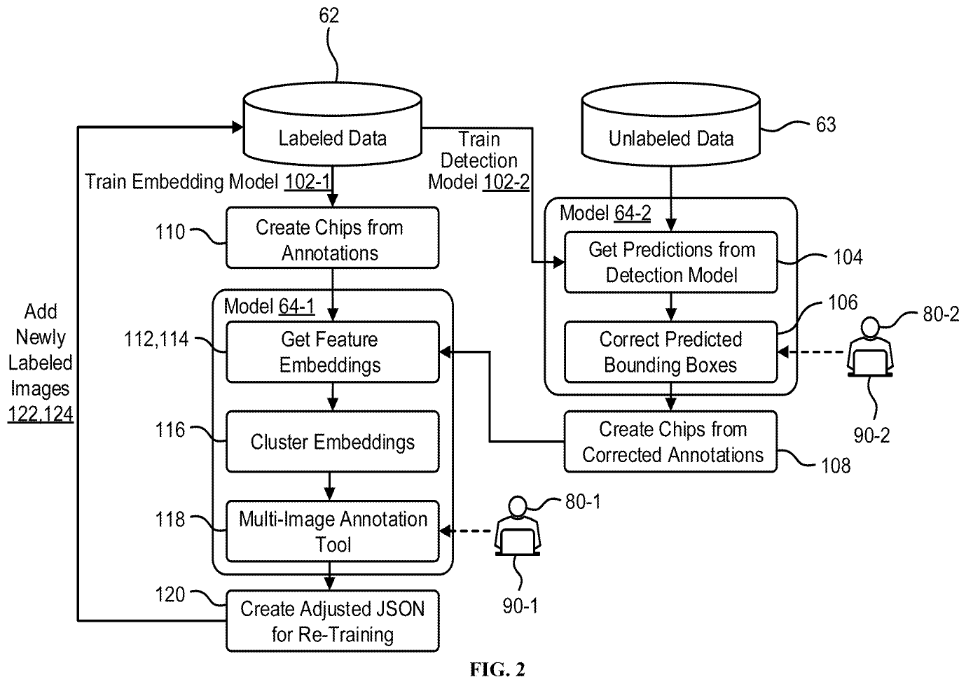

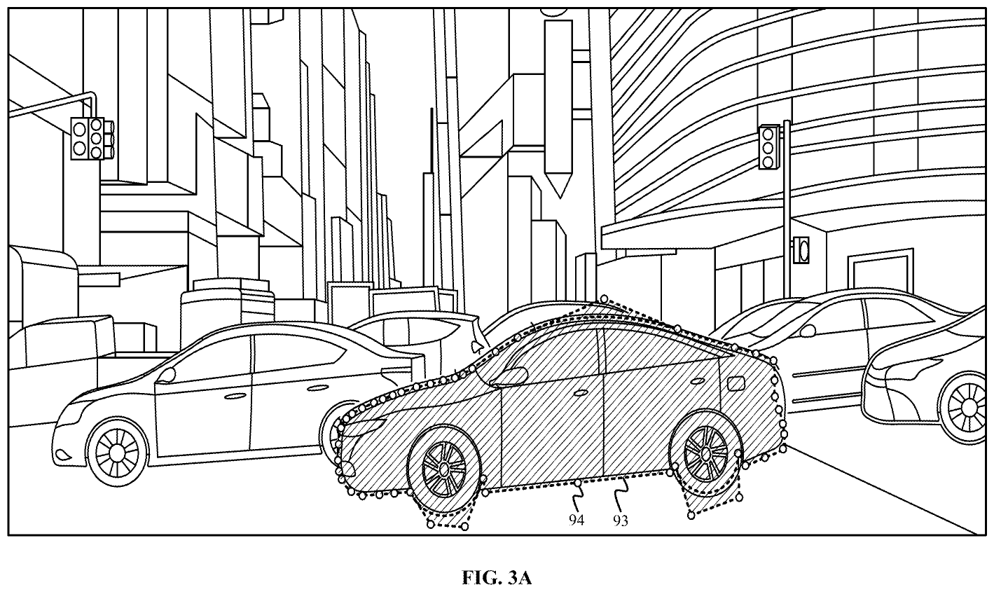

Presently disclosed are ways of system 10 of FIG. 1 performing semi-automated or fully-automated labeling of a large quantity of unlabeled data, in a set of pipelines comprising two machine learning models 64. Each of these two models of FIGS. 1-2 may be trained via supervised machine learning. One of them may learn how to predict bounding polygons around a set of objects (e.g., which are desirable, in the foreground, preselected, and/or another aspect of an object) within images, and the other model may learn a compressed feature embedding for an image of an object.

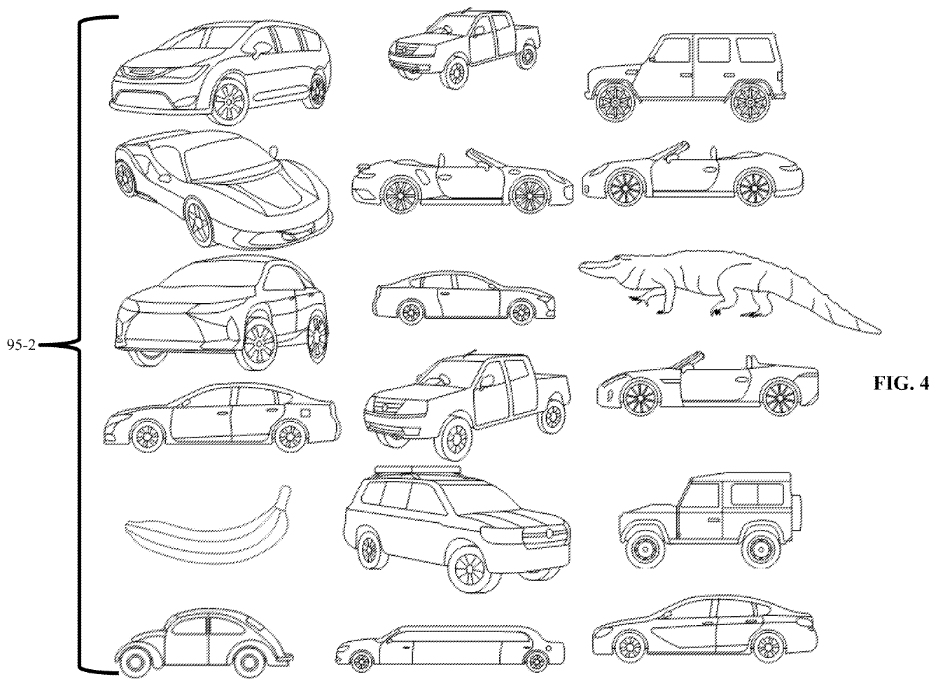

More particularly, bounding polygon detection model 64-2 may be used, e.g., to seed a human annotation tool with high quality bounding polygon proposals 93 thereby reducing the need for humans to predict a tight polygon for every detection. And embedding model 64-1 may be used, e.g., to learn a compressed feature of an object embedded in an image and then to cluster the proposed bounding polygons and/or the annotated bounding polygons; as a result of this clustering, model 64-1 may suggest a class label based upon a clustering algorithm thereby reducing the need for humans to label each object of the cluster. A clustering technique may thus be used to automatically group similar objects into sets, one such set being depicted in FIG. 4.

After each cycle of labeling data portions (or chips) that were previously unlabeled, these models may be retrained so that the process can begin anew with more unlabeled data 63. That is, models 64 may be deployed as a trained neural network for predicting presence of objects of interest.

Labeled data 62 may initially begin as unlabeled content, which may be captured with any suitable sensor, such as a light exposure sensor or camera (e.g., to capture colors and sizes of objects), but these inputted content items may be captured with any other type of sensor, such as a motion sensor, infrared sensor, oxygen sensor, temperature sensor, video camera, infrared (IR) sensor, microwave sensor, LIDAR, microphone, olfactory sensor, haptic sensor, bodily secretion sensor (e.g., pheromones), ultrasound sensor, or another sensing device. Objects of the captured content may then be manually labeled.

Artificial neural networks (ANNs) are models used in machine learning and may include statistical learning algorithms conceived from biological neural networks (particularly of the brain in the central nervous system of an animal) in machine learning and cognitive science. ANNs may refer generally to models that have artificial neurons (nodes) forming a network through synaptic interconnections (weights), and acquires problem-solving capability as the strengths of the interconnections are adjusted, e.g., at least throughout training. The terms ‘artificial neural network’ and ‘neural network’ may be used interchangeably herein.

An ANN may be configured to determine a classification (e.g., type of object) based on input image(s) or other sensed information. An ANN is a network or circuit of artificial neurons or nodes. Such artificial networks may be used for predictive modeling.

The prediction models may be and/or include one or more neural networks (e.g., deep neural networks, artificial neural networks, or other neural networks), other machine learning models, or other prediction models. As an example, the neural networks referred to variously herein may be based on a large collection of neural units (or artificial neurons). Neural networks may loosely mimic the manner in which a biological brain works (e.g., via large clusters of biological neurons connected by axons). Each neural unit of a neural network may be connected with many other neural units of the neural network. Such connections may be enforcing or inhibitory, in their effect on the activation state of connected neural units. These neural network systems may be self-learning and trained, rather than explicitly programmed, and may perform significantly better in certain areas of problem solving, as compared to traditional computer programs. In some embodiments, neural networks may include multiple layers (e.g., where a signal path traverses from input layers to output layers). In some embodiments, back propagation techniques may be utilized to train the neural networks, where forward stimulation is used to reset weights on the front neural units. In some embodiments, stimulation and inhibition for neural networks may be more free-flowing, with connections interacting in a more chaotic and complex fashion.

Disclosed implementations of artificial neural networks may apply a weight and transform the input data by applying a function, this transformation being a neural layer. The function may be linear or, more preferably, a nonlinear activation function, such as a logistic sigmoid, hyperbolic tangent (Tanh), or rectified linear activation function (ReLU) function. Intermediate outputs of one layer may be used as the input into a next layer. The neural network through repeated transformations learns multiple layers that may be combined into a final layer that makes predictions. This learning (i.e., training) may be performed by varying weights or parameters to minimize the difference between the predictions and expected values. In some embodiments, information may be fed forward from one layer to the next. In these or other embodiments, the neural network may have memory or feedback loops that form, e.g., a neural network. Some embodiments may cause parameters to be adjusted, e.g., via back-propagation.

Each of the herein-disclosed ANNs may be characterized by features of its model, the features including an activation function, a loss or cost function, a learning algorithm, an optimization algorithm, and so forth. The structure of an ANN may be determined by a number of factors, including the number of hidden layers, the number of hidden nodes included in each hidden layer, input feature vectors, target feature vectors, and so forth. Hyperparameters may include various parameters which need to be initially set for learning, much like the initial values of model parameters. The model parameters may include various parameters sought to be determined through learning. And the hyperparameters are set before learning, and model parameters can be set through learning to specify the architecture of the ANN.

Learning rate and accuracy of each ANN may rely not only on the structure and learning optimization algorithms of the ANN but also on the hyperparameters thereof. Therefore, in order to obtain a good learning model, it is important to choose a proper structure and learning algorithms for the ANN, but also to choose proper hyperparameters. The hyperparameters may include initial values of weights and biases between nodes, mini-batch size, iteration number, learning rate, and so forth. Furthermore, the model parameters may include a weight between nodes, a bias between nodes, and so forth. In general, the ANN is first trained by experimentally setting hyperparameters to various values, and based on the results of training, the hyperparameters can be set to optimal values that provide a stable learning rate and accuracy.

Some embodiments of models 64 may comprise a CNN. A CNN may comprise an input and an output layer, as well as multiple hidden layers. The hidden layers of a CNN typically comprise a series of convolutional layers that convolve with a multiplication or other dot product. The activation function is commonly a RELU layer, and is subsequently followed by additional convolutions such as pooling layers, fully connected layers and normalization layers, referred to as hidden layers because their inputs and outputs are masked by the activation function and final convolution.

The CNN computes an output value by applying a specific function to the input values coming from the receptive field in the previous layer. The function that is applied to the input values is determined by a vector of weights and a bias (typically real numbers). Learning, in a neural network, progresses by making iterative adjustments to these biases and weights. The vector of weights and the bias are called filters and represent particular features of the input (e.g., a particular shape).

A recurrent neural network (RNN) is a class of artificial neural networks where connections between nodes form a directed graph along a temporal sequence. Temporal dynamic behavior can be shown from the graph. RNNs employ internal state memory to process variable length sequences of inputs.

Training component 32 of FIG. 1 may prepare one or more prediction models 64 to generate predictions. Models 64 may analyze made predictions against a reference set of data called the validation set. In some use cases, the reference outputs may be provided as input to the prediction models, which the prediction model may utilize to determine whether its predictions are accurate, to determine the level of accuracy or completeness with respect to the validation set data, or to make other determinations. Such determinations may be utilized by the prediction models to improve the accuracy or completeness of their predictions. In another use case, accuracy or completeness indications with respect to the prediction models' predictions may be provided to the prediction model, which, in turn, may utilize the accuracy or completeness indications to improve the accuracy or completeness of its predictions with respect to input data. For example, a labeled training dataset may enable model improvement. That is, the training model may use a validation set of data to iterate over model parameters until the point where it arrives at a final set of parameters/weights to use in the model.

In some embodiments, training component 32 may implement an algorithm for building and training one or more deep neural networks. In some embodiments, training component 32 may train a deep learning model on training data 62 providing even more accuracy, after successful tests with this algorithm are performed and after the model is provided a large enough dataset.

A model implementing a neural network may be trained using training data obtained by information component 30 from training data 62 storage/database. The training data may include many attributes of objects or other portions of a content item. For example, this training data obtained from prediction database 60 of FIG. 1 may comprise hundreds, thousands, or even many millions of pieces of information (e.g., images or other sensed data) describing objects. The dataset may be split between training, validation, and test sets in any suitable fashion. For example, some embodiments may use about 60% or 80% of the images for training or validation, and the other about 40% or 20% may be used for validation or testing. In another example, training component 32 may randomly split the labelled images, the exact ratio of training versus test data varying throughout. When a satisfactory model is found, training component 32 may, e.g., train it on 95% of the training data and validate it further on the remaining 5%.

The validation set may be a subset of the training data, which is kept hidden from the model to test accuracy of the model. The test set may be a dataset, which is new to the model to test accuracy of the model. The training dataset used to train prediction models 64 may leverage, via inference component 34, an SQL server, and/or a Pivotal Greenplum database for data storage and extraction purposes.

In some embodiments, training component 32 may be configured to obtain training data from any suitable source, via electronic storage 22, external resources 24 (e.g., which may include sensors), network 70, and/or user interface (UI) device(s) 18. The training data may comprise captured images, smells, light/colors, shape sizes, noises or other sounds, and/or other discrete instances of sensed information.

In some embodiments, training component 32 may enable one or more prediction models 64-1 to be trained. The training of the neural networks may be performed via several iterations. For each training iteration, a classification prediction (e.g., output of a layer) of the neural network(s) may be determined and compared to the corresponding, known classification. For example, sensed data known to capture an environment comprising dynamic and/or static objects may be input, during the training or validation, into the neural network to determine whether the prediction model may properly predict an unseen object's presence therein. As such, the neural networks may be configured to receive at least a portion of the training data as an input feature space. Once trained, the model(s) may be stored in database/storage 64 of prediction database 60, as shown in FIG. 1, and then used to classify samples of images based on attributes.

Electronic storage 22 of FIG. 1 comprises electronic storage media that electronically stores information. The electronic storage media of electronic storage 22 may comprise system storage that is provided integrally (i.e., substantially non-removable) with system 10 and/or removable storage that is removably connectable to system 10 via, for example, a port (e.g., a USB port, a firewire port, etc.) or a drive (e.g., a disk drive, etc.). Electronic storage 22 may be (in whole or in part) a separate component within system 10, or electronic storage 22 may be provided (in whole or in part) integrally with one or more other components of system 10 (e.g., a user interface device 18, processor 20, etc.). In some embodiments, electronic storage 22 may be located in a server together with processor 20, in a server that is part of external resources 24, in user interface devices 18, and/or in other locations. Electronic storage 22 may comprise a memory controller and one or more of optically readable storage media (e.g., optical disks, etc.), magnetically readable storage media (e.g., magnetic tape, magnetic hard drive, floppy drive, etc.), electrical charge-based storage media (e.g., EPROM, RAM, etc.), solid-state storage media (e.g., flash drive, etc.), and/or other electronically readable storage media. Electronic storage 22 may store software algorithms, information obtained and/or determined by processor 20, information received via user interface devices 18 and/or other external computing systems, information received from external resources 24, and/or other information that enables system 10 to function as described herein.

External resources 24 may include sources of information (e.g., databases, websites, etc.), external entities participating with system 10, one or more servers outside of system 10, a network, electronic storage, equipment related to Wi-Fi technology, equipment related to Bluetooth® technology, data entry devices, a power supply (e.g., battery powered or line-power connected, such as directly to 110 volts AC or indirectly via AC/DC conversion), a transmit/receive element (e.g., an antenna configured to transmit and/or receive wireless signals), a network interface controller (NIC), a display controller, a set of graphics processing units (GPUs), and/or other resources. In some implementations, some or all of the functionality attributed herein to external resources 24 may be provided by other components or resources included in system 10. Processor 20, external resources 24, UI device 18, electronic storage 22, a network, and/or other components of system 10 may be configured to communicate with each other via wired and/or wireless connections, such as a network (e.g., a local area network (LAN), the Internet, a wide area network (WAN), a radio access network (RAN), a public switched telephone network (PSTN), etc.), cellular technology (e.g., GSM, UMTS, LTE, 5G, etc.), Wi-Fi technology, another wireless communications link (e.g., radio frequency (RF), microwave, IR, ultraviolet (UV), visible light, cm wave, mm wave, etc.), a base station, and/or other resources.

UI device(s) 18 of system 10 may be configured to provide an interface between one or more users and system 10. UI devices 18 are configured to provide information to and/or receive information from the one or more users. UI devices 18 include a UI and/or other components. The UI may be and/or include a graphical UI (GUI) configured to present views and/or fields configured to receive entry and/or selection with respect to particular functionality of system 10, and/or provide and/or receive other information. In some embodiments, the UI of UI devices 18 may include a plurality of separate interfaces associated with processors 20 and/or other components of system 10. Examples of interface devices suitable for inclusion in UI device 18 include a touch screen, a keypad, touch sensitive and/or physical buttons, switches, a keyboard, knobs, levers, a display, speakers, a microphone, an indicator light, an audible alarm, a printer, and/or other interface devices. The present disclosure also contemplates that UI devices 18 include a removable storage interface. In this example, information may be loaded into UI devices 18 from removable storage (e.g., a smart card, a flash drive, a removable disk) that enables users to customize the implementation of UI devices 18.

In some embodiments, UI devices 18 are configured to provide a UI, processing capabilities, databases, and/or electronic storage to system 10. As such, UI devices 18 may include processors 20, electronic storage 22, external resources 24, and/or other components of system 10. In some embodiments, UI devices 18 are connected to a network (e.g., the Internet). In some embodiments, UI devices 18 do not include processor 20, electronic storage 22, external resources 24, and/or other components of system 10, but instead communicate with these components via dedicated lines, a bus, a switch, network, or other communication means. The communication may be wireless or wired. In some embodiments, UI devices 18 are laptops, desktop computers, smartphones, tablet computers, and/or other UI devices.

Data and content may be exchanged between the various components of the system 10 through a communication interface and communication paths using any one of a number of communications protocols. In one example, data may be exchanged employing a protocol used for communicating data across a packet-switched internetwork using, for example, the Internet Protocol Suite, also referred to as TCP/IP. The data and content may be delivered using datagrams (or packets) from the source host to the destination host solely based on their addresses. For this purpose the Internet Protocol (IP) defines addressing methods and structures for datagram encapsulation. Of course other protocols also may be used. Examples of an Internet protocol include Internet Protocol Version 4 (IPv4) and Internet Protocol Version 6 (IPv6).

In some embodiments, processor(s) 20 may form part (e.g., in a same or separate housing) of a user device, a consumer electronics device, a mobile phone, a smartphone, a personal data assistant, a digital tablet/pad computer, a wearable device (e.g., watch), augmented reality (AR) googles, virtual reality (VR) googles, a reflective display, a personal computer, a laptop computer, a notebook computer, a work station, a server, a high performance computer (HPC), a vehicle (e.g., embedded computer, such as in a dashboard or in front of a seated occupant of a car or plane), a game or entertainment system, a set-top-box, a monitor, a television (TV), a panel, a space craft, or any other device. In some embodiments, processor 20 is configured to provide information processing capabilities in system 10. Processor 20 may comprise one or more of a digital processor, an analog processor, a digital circuit designed to process information, an analog circuit designed to process information, a state machine, and/or other mechanisms for electronically processing information. Although processor 20 is shown in FIG. 1 as a single entity, this is for illustrative purposes only. In some embodiments, processor 20 may comprise a plurality of processing units. These processing units may be physically located within the same device (e.g., a server), or processor 20 may represent processing functionality of a plurality of devices operating in coordination (e.g., one or more servers, user interface devices 18, devices that are part of external resources 24, electronic storage 22, and/or other devices).

As shown in FIG. 1, processor 20 is configured via machine-readable instructions to execute one or more computer program components. The computer program components may comprise one or more of information component 30, training component 32, inference component 34, and/or other components. Processor 20 may be configured to execute components 30, 32, and/or 34 by: software; hardware; firmware; some combination of software, hardware, and/or firmware; and/or other mechanisms for configuring processing capabilities on processor 20.

It should be appreciated that although components 30, 32, and 34 are illustrated in FIG. 1 as being co-located within a single processing unit, in embodiments in which processor 20 comprises multiple processing units, one or more of components 30, 32, and/or 34 may be located remotely from the other components. For example, in some embodiments, each of processor components 30, 32, and 34 may comprise a separate and distinct set of processors. The description of the functionality provided by the different components 30, 32, and/or 34 described below is for illustrative purposes, and is not intended to be limiting, as any of components 30, 32, and/or 34 may provide more or less functionality than is described. For example, one or more of components 30, 32, and/or 34 may be eliminated, and some or all of its functionality may be provided by other components 30, 32, and/or 34. As another example, processor 20 may be configured to execute one or more additional components that may perform some or all of the functionality attributed below to one of components 30, 32, and/or 34.

In some embodiments, information component 30 is configured to initially obtain training images from electronic storage 22, external resources 24, and/or via user interface device(s) 18. In some embodiments, information component 30 is connected to network 70. The connection to network 70 may be wireless or wired.

In some embodiments, training component 32 and/or inference component 34 may cause implementation of deep learning. The deep learning may be performed via one or more ANNs.

Each model of prediction models 64 may, e.g., include an input layer, one or more other layers, and an output layer. The one or more other layers may comprise a convolutional layer, activation layer, and/or pooling layer. The number and type of layers is not intended to be limiting. Artificial neurons may perform calculations using one or more parameters, and there may be connections from the output of one neuron to the input of another. The extracted features from multiple independent paths of attribute detectors may, e.g., be combined. For example, their outputs may be fed as a single input vector to a fully connected neural network to produce a prediction on the class of an object in the image.

R-CNN may use selective search to extract regions of interest (ROIs), where each ROI is a polygon that most probably represents the boundary of an object in image. For each ROIs' output features, a collection of support-vector machine classifiers may be used to determine what type of object (if any) is contained within the ROI.

Fast R-CNN may run a neural network once on the whole image, and it may conclude with an ROI pooling layer, which may slice out each ROI from the network's output tensor, reshape it, and classify it. As in the original R-CNN, fast R-CNN uses selective search to generate its region proposals. The architecture is trained end-to-end with a multi-task loss.

Faster R-CNN integrates the ROI generation into the neural network itself. Faster R-CNN solves bottlenecked CNN by abandoning the traditional region proposal method, and relying on a fully deep learning approach. It may comprise two modules: a region proposal network (RPN) CNN and a fast R-CNN detector. Faster R-CNN may use a classifier with two possible classes: one for having an object and the other for background class. Faster R-CNN may be used to predict offsets like δx, δy that are relative to the top left corner of some reference polygon (which encode proposals, the proposal being parametrized with coordinates of polygonal vertices relative to an anchor box, for example) called anchors. Anchors are also called priors or default boundary boxes.

A mask R-CNN may be a fully convolutional head for predicting masks, which may resize the prediction and generate the mask. These region-based techniques may limit a classifier to the specific region. Mask R-CNN may perform instance segmentation and the ROI align function, and thus bilinear interpolation to compute the exact values of the input features. The first stage (region proposal) of mask R-CNN may be identical to faster R-CNN, while in the second stage it may output a binary mask for each ROI in parallel to the class and bounding box. This binary mask denotes whether the pixel is part of any object, without concern for the categories.

By contrast, a you only look once (YOLO) technique may access the whole image in predicting boundaries, and it may: (i) detect in real-time which objects are where; (ii) predict bounding boxes; and/or (iii) give a confidence score for each prediction of an object being in the bounding box and of a class of that object by dividing an image into a grid of bounding boxes; each grid cell may be evaluated to predict only one object. As such, YOLO may be used to build a CNN network to predict a tensor, wherein the bounding boxes or ROIs are selected for each portion of the image. YOLO only needs one forward propagation to detect all objects in an image. And YOLO models object detection as a regression problem.

With respect to the aforementioned approaches, mesh R-CNN adds the ability to generate a three-dimensional (3D) mesh from a two-dimensional (2D) image.

Also contemplated for one or more of models 64 is a support vector machine (SVM), singular value decomposition (SVD), deep neural network (DNN), densely connected convolutional networks (DenseNets), hidden Markov model (HMM), and Bayesian network (BN).

In some embodiments, model 64-2 may be a faster R-CNN model. Contemplated alternatives to faster R-CNN include, e.g., (i) any suitable, two-stage detector such as region-based fully convolutional network (R-FCN), mask R-CNN, mesh R-CNN or (ii) any suitable, one-stage detector such as YOLO, recurrent YOLO (ROLO), RetinaNet, and singe shot multibox detector (SSD). In the first stage, a sparse set of region proposals may be generated (e.g., by having a polygonal bounding box of all possible objects). And a second stage may classify each proposal (e.g., by assigning a class label to each bounding box) and refine its location.

In some embodiments, an RPN of model 64-2 may be configured to obtain feature vectors and create class-agnostic region proposals by sliding a small network or filter over a last convolution layer. In this example, the small network may have as input a window (e.g., n×n) of the convolutional feature map. Each sliding window may be mapped to a lower-dimensional feature and provided to fully connected layer(s). The RPN may, e.g., take as input an unlabeled image (e.g., of any size) and output a set of polygonal object proposals, each having an objectness score.

In some embodiments, models 64 may implement a box-classification and/or box-regression layer. For example, one or more of these models may perform regression and/or classification. More particularly, there may be a regression layer for predicting the box parameters of all proposals, e.g., including a classification layer for predicting the object background probabilities of all proposals.

In some embodiments, object prediction model 64-2 may be, e.g., a fully convolutional network that efficiently predicts region proposals with a wide range of scales and aspect ratios. Each such proposal may contain, e.g., an object (e.g., car, person, cat, tree, etc.).

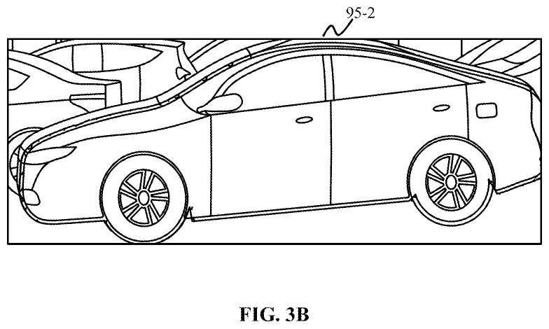

In some embodiments, bounding polygons 93 predicted by model 64-2 may be two-dimensional (2D). In other embodiments, bounding polygons 93 predicted by model 64-2 may be three-dimensional (3D). Although polygons 93 are used here to describe anchors that have vertices 94 around object of interest 92 (e.g., car), as depicted in FIG. 3A, bounds or boundaries of the object of interest may comprise one or more Bézier curves. And although FIGS. 3A and 4 show cars or utility vehicles as the objects of interest, any object is contemplated by the herein-disclosed approach, including people, trucks, train, bicycles, motorcycles, scooter, traffic signs, traffic lights, trees, planes, etc.

As depicted in FIG. 3A, bounding polygon 93 may comprise straight line segments connected via vertices 94 or comprise curved (e.g., Bézier) segments connected between such vertices. In some embodiments, bounding polygon 93 may entirely enclose the object. In other embodiments, one or more portions of the object may extend beyond the bounds or contour of polygon 93.

As depicted in FIG. 3B, a chip may be a crop out of the original image (e.g., a content item from labeled database 62 and/or unlabeled database 63) and commensurate-with or within the coordinates from the annotation (i.e., when obtained from database 62) or from neural network 64-2 (i.e., when obtained with respect to database 63). For the latter cropping of the chip, the neural network may place bounding polygon 93 in the original image of FIG. 3A such that the cropping may be performed.

In some embodiments, model 64-2 may predict bounding polygons 93 in runtime (i.e., real-time or live) or in near real-time. Model 64-2 may be any suitable object detection model or computer vision annotation tool (e.g., which may be web browser based or implemented via a standalone software application).

In some embodiments, model 64-2 may be trained 102-2, using labeled image data 62, to identify visual objects, from among unlabeled data 63 (e.g., which may comprise dozens, hundreds, thousands, or millions of images that have no labels). In these or other embodiments, the identification may be further performed using semantic information gleaned from unannotated text of the unlabeled data. For example, labeled data 62 may initially comprise a small amount of annotated data (e.g., which may be manually labeled), and this data may be used to initially train object detection model 64-2 via supervised learning. This data may be further used to initially train embedding model 64-1 via supervised learning and via a loss function.

In some embodiments, training data 62 may be any suitable corpus of images or video, e.g., which may include hundreds or even thousands of different categories. For example, dataset 62 may have around 800 classes in the training set and 200 classes in the test set, and the classes that are in the test set may actually not be represented in the training set. So there may be no categorical overlapping between training and test, which may be significant in ascertaining whether models 64 are working properly.

In some embodiments, embedding model 64-1 may generate compact, real-valued feature vector representations of (i) each chip, which may be created from annotated data 62, and (ii) each chip 95-2, which may be created from unannotated data 63. These vectors or embeddings may be a translation of a high-dimensional vector into a low-dimensional space (e.g., to preprocess and reduce the dimensionality of high-dimensional datasets while preserving the original structure and relationships inherent to the original dataset). Such dimensionality reduction may reduce the number of variables to consider, which may increase efficiency of model 64-1. Embeddings further make it easier to do machine learning on large inputs (e.g., sparse vectors representing words or objects). In an example, the herein-disclosed embeddings may be learned and reused across models. And an embedding may be a mapping to a vector of continuous numbers such that the vectors of similar objects are closer to one another in vector space.

Embedding model 64-1 may, e.g., comprise a continuous representation of an input feature space, which is consolidated in terms of its size. With respect to this consolidation, if the actual raw input images were merely fed in, (i) the clustering may take a substantially long amount of time (e.g., because those images may be really sparse in terms of the information content of them) and (ii) the clusters may be poorly generated. System 10 improves by yielding cleaner output. For example, a specific type of object (e.g., a car) may be properly predicted, as opposed to the predicting of a label for an undesirable object (e.g., a banana or alligator), such that need for a quality control function is reduced by an extent satisfying a criterion.

In some embodiments, embedding model 64-1 may reduce the dimensionality of input data, such as images. And this model may be trained such that similar images are converted to similar vectors or representations. Embedding model 64-1 may comprise a feature extractor network and/or an embedding layer. In some embodiments, chips may be extracted from annotated database 62 and may comprise an image array (e.g., 128×128 pixels). Model 64-1 may then project this high dimensional array or matrix down to a vector (e.g., 128 in length) that succinctly describes the content of that original array. Accordingly, this model may perform a form of non-linear compression to project it down into a lower dimensional space. In an exemplary implementation, embedding dimensionalities (e.g., 128 or another suitable number) may be selected (e.g., via UI devices 18). For example, by reasoning across a 128 dimensional vector as opposed to a much higher-dimensional, original input space, model 64-1 may operate in a more computationally efficient way when clustering and performing similarity comparisons in the feature space.

In some embodiments, the feature extractor network may provide a plurality of features or feature vectors. Such extractor network may, e.g., be a deeper and densely connected backbone (e.g., ResNet, ResNeXt, AmoebaNet, AlexNet, VGGNet, Inception, etc.) or a more lightweight backbone (e.g., MobileNet, ShuffleNet, SqueezeNet, Xception, MobileNetV2, etc.), but any suitable neural network, feature extractor network, or convolutional network (e.g., CNN) is contemplated for this model.

In some embodiments, model 64-1 comprises two sets of parameters: (1) a linear mapping from image features to a joint embedding space, and (2) an embedding vector for each possible label.

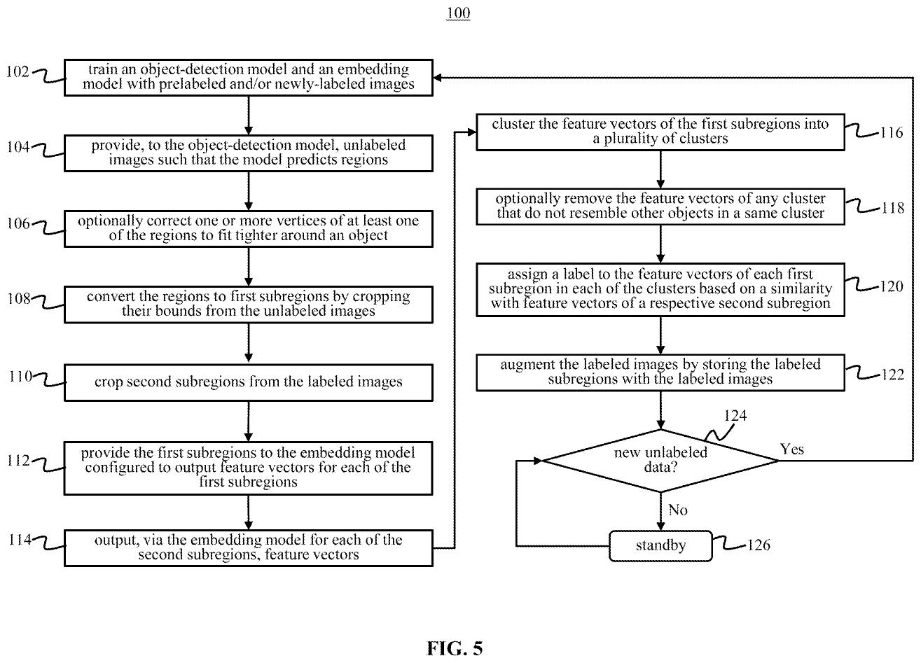

In some embodiments, embedding model 64-1 may normalize features outputted from the feature extractor network. The embeddings resulting from these features may be operated upon via a triplet loss function or another loss function, e.g., for training and/or deployment. The extractor network may obtain a compact representation that makes it easier to cluster and reason over, e.g., to organize the data so that when human 80-1 observes via system 90-1 they can remove corresponding chips 95-2 that do not belong (e.g., banana and alligator of FIG. 4 do not resemble a car), as opposed to labeling exhaustively every single chip on the screen. In other words, instead of this user going through and individually confirming that each chip is a vehicle, the clustering process creates clusters of chips (e.g., of 10, 25, 50, or another natural number) so that user 80-1 only confirms when an object does not belong to this vehicle class. For example, the user at operation 118 may only make three clicks for a cluster instead of dozens or hundreds of confirming clicks, and/or this user may determine that all (e.g., remaining) displayed chips comprise depictions of a same class (e.g., vehicle) to continue to a next cluster or another screen. With these efficiency improvements, at least a 30% gain in time saving may be achieved by just one cycle of the recited approach, e.g., as compared to known labeling approaches for the same amount of images. The approach of FIGS. 2 and 5 may thus accelerate the labeling process, e.g., when compared to purely manual (i.e., human) ways, while still preserving the quality of the labels generated. That is, object detector 64-2 may reduce bounding box labeling effort, and embedding model 64-1 may reduce class labeling effort.

Loss functions for classification are computationally feasible loss functions representing the price paid for inaccuracy of predictions. The classification problem here is identifying which category to which a particular observation belongs, i.e., whether similar to a chip from labeled data or dissimilar from the labeled data's chip. Some embodiments of system 10 may thus determine a function that best predicts a label for a given input. However, because of incomplete information, noise in the measurement, or probabilistic components in the underlying process, it is possible for the same to generate a different label. As a result, system 10 may minimize expected loss (or risk).

In some embodiments, a triplet loss model may be used. For example, the model may enforce the order of distances, e.g., by embedding such that a pair of samples with same labels are smaller in distance than those with different labels. In other embodiments, t-distributed stochastic neighbor embedding (t-SNE) may be used, e.g., to preserve embedding orders via probability distributions. For example, a nonlinear dimensionality reduction technique may be performed for embedding high-dimensional data for visualization in a low-dimensional 2D or 3D space. In yet other embodiments, other embedding losses may be operated upon, such as margin-based loss, contrastive loss, pairwise-ranking loss, triplet-ranking loss, hinge loss, Siamese loss, ranking loss, or another suitable loss function. Each of such contemplated approaches to losses may make neural network 64-1 learn when objects or things are similar and learn when they are different, e.g., to produce good embeddings.

In implementations involving margin-based loss functions a product of the true label and the predicted label may be used, upon which only one variable is operated in the function. In implementations involving ranking loss, distances between feature vectors or representations may be computed in a feature space. In implementations involving pairwise ranking loss, anchor image(s) may each be compared with positive image(s) (which are similar) and with negative image(s) (which are dissimilar) to determine the ranking loss. In implementations involving triplet ranking loss, a baseline (anchor) input may be compared to a positive (i.e., same as or similar to) input and a negative (i.e., different from) input, and a difference between distance metrics may, e.g., be compared to a margin. The distance from the baseline input to the positive input may be minimized, and/or the distance from the baseline input to the negative input may be maximized.

Some implementations may involve a triplet loss and a standard classification (e.g., cross entropy loss). In implementations involving contrastive loss, losses may contrast the representations of different input samples. In implementations involving hinge loss, a loss function may be used for training SVMs for classification. In implementations involving Siamese and triplet losses, neural networks may use ranking losses, but these losses can be used in other kinds of neural networks; representations for the different input samples may be computed with a CNN with weights that are shared for the pairs or the triplets.

In some embodiments, one machine learning model 64-1 from among a plurality may be selected for the clustering. For example, a K-nearest neighbors (KNN) algorithm may be selected to cluster chips 95-2, K being a natural number. For classification, some embodiments may find the center point of each cluster that has a minimum distance from each set of features to be clustered. For example, the distance measure may be based on Euclidean, Hamming, Manhattan, Minkowski, Tanimoto, Jaccard, Mahalanobis, and/or cosine distance. But this is not intended to be limiting, as the KNN approach may be replaced with other data point based learning approaches, such as learning vector quantization (LVQ), self-organizing map (SQM), or locally weighted learning (LWL).

Upon being provided unlabeled data 63, object detector 64-2 may make predictions on the unlabeled data. In some embodiments, user 80-2 of system 90-2 may (i) adjust or correct one or more vertices 94 of at least one of predicted bounding polygons 93 and/or (ii) slide this prediction to a more accurate location with respect to the provided image. As such, the polygonal labels may only be adjusted, without involving the class labels. Next, subregions contained in the predicted bounds may be converted to chips 95-2. Each chip may be a portion of an inputted image and enclose an object.

Then, the chips may be provided to embedding model 64-1 such that feature vectors are generated for each one of those chips. These features may be clustered such that objects with similar visual characteristics are closer together and so that model 64-1 labels many chips of each group or cluster substantially at the same time. This model may then output a JavaScript object notation (JSON) file that describes the corrected bounding boxes and appropriate class labels, the JSON being then provided to labeled database 62 so that a new cycle can begin. Accordingly, models 64 may progressively improve in their predicted outcomes such that an amount of human verification or quality assurance labor required is progressively reduced further.

In some embodiments, model 64-1 may annotate clusters of similar objects or images. As an example for performing this similarity determination, a distance between the embeddings of chips from labeled data 62 and the embeddings of chips from unlabeled data 63 may be compared against a threshold. The annotation process is thus accelerated by assigning a class label to a whole cluster of images. Then, annotator 80-1 may manually (or a contemplated process may automatically) remove images that do not belong to the cluster by clicking on these images. For example, in the cluster of FIG. 4, the banana and alligator may be removed. When all wrong images are removed, the remaining images may be provided the same label assigned by model 64-1 based on feature space similarity with the features from chips created using labeled data 62. And this feature space may be, e.g., an N-dimensional feature space, N being a natural number (which may be equal to the number of features used to train model 64-1).

In some embodiments, when the unlabeled data comprises frames of a video wherein objects are moving, interpolation may be used to predict bounding polygons for subsequent frames. Alternative to labeling image data, herein-contemplated is an approach for natural language processing. For example, rather than two pipelines, there may be just one pipeline or stage for the embedding models; and then a clustering of the word vectors may be performed to label everything.

In some embodiments, the labeling performed by the herein-disclosed approach is semi-automated by operation 106 (e.g., corrections being performed by user 80-2 using computer 90-2) and operation 118 (e.g., corrections being performed by user 80-1 using computer 90-1). In other embodiments, these operations may not be necessary (and thus not performed) or automatically performed by a component of processor 20. Operations 106 and 118 are thus each termed optional in FIG. 5 and depicted in FIG. 2 with a dotted line that represents human-directed interaction, e.g., via UI devices 18 of FIG. 1. Although 80-1 and 80-2 are depicted differently and using computer systems 90-1 and 90-2, in some implementations they may be a same person and a same computer system. Human annotations may be performed with a web browser and/or with a standalone software application.

In some embodiments, information component 30 may select the best images to label using test time augmentation. For example, if there are 10,000 images being obtained each month, and it is predetermined that there is a significant amount of correlation between the images, then of the 10,000 there may be only a portion (e.g., about 1,000 images) that are substantially more distinctive and thus not similar to all the others. System 10 may identify the distinctive portion and reduce an amount of labeling activity (e.g., by not repetitively labeling in images that are correlated to one another).

In these or other embodiments, information component 30 may perform test time augmentation by augmenting an image (e.g., from labeled database 62 and/or unlabeled database 63) during inference. For example, this component may change the image, e.g., by performing one or more of blurring, sharpening, adjusting color, adjusting contrast, adjusting brightness, scaling size, cropping, and/or another suitable operation. This may result, e.g., in several, different output image portions of the same input image. Information component 30 may then, e.g., determine how much agreement there is among respective predictions. Model 64-2 may, e.g., determine strong agreement after an image conversion. For example, a conversion to black and white and an applied blurring at a different time may result in their predictions being substantially close; then, a determination may be made that model 64-2 is sufficiently good at that image already. But, in this example, if the result was that the predictions were substantially different and if they do not agree, then a determination may be made that model 64-2 is not sufficiently good at understanding the content it observes. Accordingly, some embodiments of system 10 may use that amount of disagreement when applying a test time augmentation to better select images that are more or most informative for training.

FIG. 5 illustrates method 100 for a machine learning assisted process (e.g., which comprises two distinct pipelines) in labeling unlabeled data, in accordance with one or more embodiments. Method 100 may be performed with a computer system comprising one or more computer processors and/or other components. The processors are configured by machine readable instructions to execute computer program components. The operations of method 100 presented below are intended to be illustrative. In some embodiments, method 100 may be accomplished with one or more additional operations not described, and/or without one or more of the operations discussed. Additionally, the order in which the operations of method 100 are illustrated in FIG. 5 and described below is not intended to be limiting. In some embodiments, method 100 may be implemented in one or more processing devices (e.g., a digital processor, an analog processor, a digital circuit designed to process information, an analog circuit designed to process information, a state machine, and/or other mechanisms for electronically processing information). The processing devices may include one or more devices executing some or all of the operations of method 100 in response to instructions stored electronically on an electronic storage medium. The processing devices may include one or more devices configured through hardware, firmware, and/or software to be specifically designed for execution of one or more of the operations of method 100.

At operation 102 of method 100, object-detection model 64-1 and embedding model 64-1 may be trained, with prelabeled images 62 (and with newly-labeled images upon method 100 reentry at completion of a cycle). In some embodiments, information component 30 may be used to obtain and store these images. And operation 102 may be further performed by a processor component the same as or similar to training component 32 (shown in FIG. 1 and described herein).

At operation 104 of method 100, unlabeled images 63 may be provided to object-detection model 64-2 such that this model predicts ROIs or bounding polygons 93. In some embodiments, operation 104 is performed by a processor component the same as or similar to inference component 34 (shown in FIG. 1 and described herein).

At operation 106 of method 100, one or more vertices 94 of at least one ROI 93 may be optionally corrected to fit better (e.g., looser or tighter) around an object. Alternatively, if machine learning model 64-2 failed to predict presence of an entity (e.g., by not bounding an object in a polygon), human 80-2 may then come in and draw polygon 93; but this type of correction is only contemplated as a fail-safe. In some embodiments, operation 106 is automatically performed by a component of processor 20 or manually performed via computer 90-2.

At operation 108 of method 100, ROIs 93 may be converted to first subregions by cropping their bounds from each unlabeled image obtained from database 63. In some embodiments, operation 108 is performed to produce chips 95-2 using model 64-2 and/or a processor component the same as or similar to information component 30 (shown in FIGS. 1-2 and described herein).

At operation 110 of method 100, second subregions or chips may be cropped from labeled images 62. In some embodiments, operation 110 is performed using model 64-1 and/or a processor component the same as or similar to information component 30 (shown in FIGS. 1-2 and described herein).

At operation 112 of method 100, the first subregions or chips 95-2 may be provided to embedding model 64-1, which may be configured to output feature vectors for each of these subregions or chips. In some embodiments, operation 112 is performed using model 64-1 and a processor component the same as or similar to inference component 34 (shown in FIGS. 1-2 and described herein).

At operation 114 of method 100, feature vectors may be outputted by embedding model 64-1, for each of the second subregions. In some embodiments, operation 114 is performed using model 64-1 and a processor component the same as or similar to inference component 34 (shown in FIGS. 1-2 and described herein).

At operation 116 of method 100, the feature vectors of the first subregions may be clustered into a plurality of clusters. In some embodiments, the unsupervised learning of operation 116 may be performed by model 64-1.

At operation 118 of method 100, the feature vectors of any cluster that do not resemble other objects in a same cluster may be optionally removed. In some embodiments, operation 118 is automatically performed by a component of processor 20 or manually performed via computer 90-1.

At operation 120 of method 100, a label may be assigned to the feature vectors of each first subregion in each of the clusters based on a similarity with feature vectors of a respective second subregion. In some embodiments, operation 120 is performed using model 64-1 and a processor component the same as or similar to inference component 34.

At operation 122 of method 100, the labeled images of database 62 may be augmented by storing the newly labeled subregions with these initially labeled images. In some embodiments, operation 122 is performed by a processor component the same as or similar to information component 30.

At operation 124 of method 100, a determination may be made as to whether new unlabeled data has been stored in database 63. If there is new unlabeled data, then method 100 may be reentered at operation 102. But if no new unlabeled data is available, then standby operation 126 may be continually entered until there is such available. For example, machine learning system 10 may be obtaining 10,000 images every month. An initial iteration through the two pipelines may cause trained models 64 to predict bounds and labels for these 10,000 images. In this example, next month when the next 10,000 image batch is obtained these pipelines may be reapplied, but with more effective training each round. That is, every time the models are provided more labeled data they will predict more accurately, which may continually reduce any need for a human to be involved in assuring quality predictions are being made.

Techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device, in machine-readable storage medium, in a computer-readable storage device or, in computer-readable storage medium for execution by, or to control the operation of, data processing apparatus, a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques can be performed by one or more programmable processors executing a computer program to perform functions of the techniques by operating on input data and generating output. Method steps can also be performed by, and apparatus of the techniques can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, such as, magnetic, magneto-optical disks, or optical disks. Information carriers suitable for embodying computer program instructions and data include all forms of non-volatile memory, including by way of example semiconductor memory devices, such as, EPROM, EEPROM, and flash memory devices; magnetic disks, such as, internal hard disks or removable disks; magneto-optical disks; and CD-ROM and DVD-ROM disks. The processor and the memory can be supplemented by, or incorporated in special purpose logic circuitry.

Several embodiments of the disclosure are specifically illustrated and/or described herein. However, it will be appreciated that modifications and variations are contemplated and within the purview of the appended claims.

What is claimed is:

1. A method for labeling data, the method comprising the following steps:
A) providing, to an object-detection, machine-learning (ML) model, a plurality of unlabeled data such that the object-detection model predicts a plurality of regions;
B) correcting at least one vertex of bounds of at least one of the regions such that the bounds fit tighter around an object;
C) converting the regions to first subregions by cropping the first subregions from the unlabeled data; and
D) providing the first subregions to an embedding, ML model configured to output feature vectors for each of the first subregions.

2. The method of claim 1, further comprising:
cropping second subregions from labeled data; and
outputting, via the embedding model for each of the second subregions, feature vectors.

3. The method of claim 2, further comprising:
clustering the feature vectors of the first subregions into a plurality of clusters.

4. The method of claim 3, further comprising:
removing, via a user interface, the feature vectors of any cluster that do not resemble other objects in a same cluster.

5. The method of claim 4, further comprising:
automatically assigning a label to all of the feature vectors of the each first subregion in one of the clusters based on a similarity with the feature vectors of one of the second subregions; and
automatically assigning a different label to all of the feature vectors of the each first subregion in another one of the clusters based on a similarity with the feature vectors of another one of the second subregions.

6. The method of claim 2, further comprising:
augmenting the labeled data by storing the automatically-labeled subregions with the labeled data; and
repeating steps A-D using the augmented data and a new set of unlabeled data.

7. The method of claim 2, wherein the embedding model reduces dimensionality in the outputting of the feature vectors.

8. The method of claim 6, further comprising:
training both the object-detection model and the embedding model using the labeled data or the augmented data.

9. A method for labeling data, the method comprising:
obtaining labeled data;
cropping second subregions from the labeled data; and
obtaining first subregions that are cropped from regions predicted by an object-detection model;
outputting, via an embedding model for each of the first and second subregions, feature vectors; and
clustering the feature vectors of the first subregions such that a label is determined for all subregions of each cluster, each of the determinations being based on the feature vectors of the second subregions.

10. The method of claim 9, wherein the embedding model is an ML model trained via supervised learning using the labeled data, and wherein the object-detection model is another different ML model trained via supervised learning using the labeled data.

11. The method of claim 9, further comprising:
removing, via a user interface, the feature vectors of any cluster that do not resemble other objects in a same cluster.

12. The method of claim 9, further comprising:
automatically assigning a label to all of the feature vectors of the each first subregion in one of the clusters based on a similarity with the feature vectors of one of the second subregions; and
automatically assigning a different label to all of the feature vectors of the each first subregion in another one of the clusters based on a similarity with the feature vectors of another one of the second subregions.

13. The method of claim 12, further comprising:
augmenting the labeled data by storing the automatically-labeled subregions with the labeled data.

14. The method of claim 9, wherein the embedding model reduces dimensionality in the outputting of the feature vectors.

15. The method of claim 13, further comprising:
training both the object-detection model and the embedding model using the augmented data.

16. A system, comprising:
a first pipeline for creating first subregions from regions predicted in real-time; and
a second pipeline for creating second subregions from labeled regions and for labeling the first subregions, respectively in each of the clusters, using feature vectors generated from the second subregions.

17. The system of claim 16, wherein the first pipeline comprises a first ML model that is trained via supervised learning, and
wherein the second pipeline comprises a second ML model that is trained via triplet loss.

18. The system of claim 17, wherein the labeling is performed by clustering the first subregions into a plurality of clusters using feature vectors generated from the first subregions.

19. The system of claim 18, wherein all of the feature vectors are generated as part of the second pipeline.

20. The system of claim 19, wherein the first and second pipelines are reentered, and wherein the first and second ML models are retrained, using the labeled first subregions.
